(19) United States
(12) Patent Application Publication
(10) Pub. No.: US 2008/0187297 A1
(43) Pub. Date: Aug. 7, 2008

(54) Methid, End User System, Signal and Transmission System for Combining Broadcasted Audio-Video Content with Locally Available Information

(75) Inventors: Sander Rudolfus Kooijmans, Eindhoven (NL); Koen Johanna Guillaume Holtman, Eindhoven (NL); Hendrik Frank Moll, Eindhoven (NL); Petrus Nicolaas Wouters, Eindhoven (NL); Philip Steven Newton, Eindhoven (NL); Michiel Josephus Christianen, ZUNDERT (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,133

(22) PCT Filed: Apr. 15, 2006
(86) PCT No.: PCT/IB06/51069

§ 371 Date: Oct. 10, 2007

(30) Foreign Application Priority Data
Apr. 15, 2005 (EP) 05103003.9

(51) Int. Cl. H04N 7/173; H04N 5/00

(52) U.S. Cl. 386/125; 725/118

(57) ABSTRACT

Method, end user system, transmission system, computer software product and broadcasted signal for enhancing the user experience of a broadcast via an interactive playback combining a broadcasted signal with a signal comprising additional information stored locally. A broadcasted software application detects the presence in the end user system (for example a set top box or a digital television set) of a suitable media player (for example a Blu-ray Disc player) and of a desired media (for example BD-ROM) and consequently enhances the broadcast by using the content stored on the media.

The present invention relates to a method of combining a signal comprising additional information with a broadcasted signal representing audio-video content in order to enhance a user experience of the broadcasted audio-video content according to the precharacterizing part of claim 1. This invention also relates to an end user system as described in the preamble of claim 12. This invention also relates to a corresponding transmission system as described in the preamble of claims 15. This invention also relates to signal corresponding to a broadcasted signal according to the precharacterizing part of claim 21. This invention also relates to a computer software product operative to implementing the said method of combining a signal comprising additional information with a broadcasted signal of claim 1.

New forms of consumer electronics are continually being developed. Many efforts have been focused on the convergence of computer technology and home entertainment systems that center on the television (TV) set. Important areas are interactive television and enhanced functionality, by merging broadcasted audio-video content with additional information. Several industry discussion forums in the area of Digital Video Broadcast (DVB) like the European MHP (Multimedia Home Platform) or the US Dase Platform disclose the use of Internet resources to enhance functionality. WO 01/11874 describes a system wherein website addresses in the form of uniform resource locators (URL) are included in the broadcasted TV signals. When prompted by a message in the TV broadcast, the users may select one or more URLs to contact a website over Internet and, optionally upon further identification or payment, they may obtain additional information relating to the broadcast. However, a user may desire an enhanced experience of a broadcasted audio-video content while not having a suitable Internet connection available.

It is an object of the invention to provide an improved method for combining a signal comprising additional information with a broadcasted signal representing audio-video content. The object is achieved by a method according to the invention, as recited in the characterizing part of claim 1. The method combines with the broadcasted audio-video content additional information extracted from information that is available locally, thus allowing an enhanced user experience even if an Internet connection is not available, or the Internet connection is present but it is not suitable for the desired purpose. For example, during the broadcast of a soccer match, a broadcasted control sequence uses a locally available optical disc comprising information about soccer. In this case a downscaled movie (picture in picture) from the disc about the players may be displayed, or additional information about the players may be extracted and displayed. Or during a movie, information about actors, director, etc. may be extracted and displayed on screen from additional information accompanying a second movie featuring the same actors or director, the second movie and the accompanying information being available locally.

An advantageous embodiment can be obtained according to the measures of claim 2. Including a checking step, for checking if a suitable player is available in the end user system, and an identification step, comprising identifying if a desired media storing the additional information is available, are beneficial as the broadcaster of the audio-video content cannot have prior knowledge about available resources of a given end user system.

In a first embodiment, the determination of locally available resources in the checking and identification steps can be obtained by interactively querying user about the said resources. This mitigates the problem of correctly identifying a suitable player and a desired media.

A second embodiment can be used to advantage according to the measures of claim 4. Executing a test sequence for testing if a suitable player is present in the end user system in the checking step alleviates the problem that an end-user might not be aware of the exact technical details of the end user system. For instance a test sequence may comprise a sequence operative to inducing the end user system to attempt reading information from the desired media. In an advantageous embodiment according to claim 5, the test sequence is comprised in the broadcasted signal, therefore avoiding relying on the unknown resources of the end user system.

In a more advantageous embodiment, the checking step comprises checking information stored by the end user system, operative to determining whether a suitable player is present in the end user system. This obviates the problem of the second embodiment that attempting reading information from a desired media fails in the case of a removable media if no media is inserted in the player. Optionally, instead of checking information stored by the end user system, the checking step may comprise executing a function available to the end user system, operative to determining whether a suitable content player is available.

With respect to Digital Rights Management (DRM), media comprising copyrighted information may also comprise protection so that only authenticated control sequences may executed while attempting to reading the copyrighted information. Consequently, it is advantageous that the control sequence may further comprise information corresponding to an identification key. This allows the use of protected copyrighted information in the combined output step of the method.

It is desirable that in the combined output step, the end user may select the specific pieces of additional information that are used in the combined output step or in selecting a mode of usage for the pieces of additional information.

The invention also includes an end user system according to claim 12. Identification means adapted to identify the presence of playback means solves the problem of how to allow a broadcasted control sequence to reliably identify available playback means. In a first embodiment of the end user system, according to the measures of claim 13, the identification of playback means is realized by means storing information locally whether a suitable player is available. According to a second embodiment of the end user system, the identification is realized by function execution means, adapted to determining when executed whether a suitable content player is present in the end user system. Both embodiments carry the advantage that they are simple to implement by means of firmware avoiding costly hardware modifications.

The invention also includes a transmission system according to claim 15. The transmission system allows an enhanced user experience by providing a combined output of a broadcasted audio-video content with additional information that is retrieved from information stored locally. Therefore, the transmission system allows an enhanced user experience even if an Internet connection is not available. An improved embodiment is obtained by measures of claim 16. Enabling the controller means of the end user system to determine if a suitable player for playing information stored locally is available and to identify if a desired media is available is advantageous as the broadcaster of the audio-video content cannot have prior knowledge about available resources of a given end user system.

The invention also includes a signal corresponding to a broadcasted signal according to claim 21.

The invention also includes a computer application product according to claim 17.

These and other aspects of the invention are apparent from and will be explained with reference to the embodiments described hereinafter.

The features and advantages of the invention will be appreciated upon reference to the following drawings, in which:

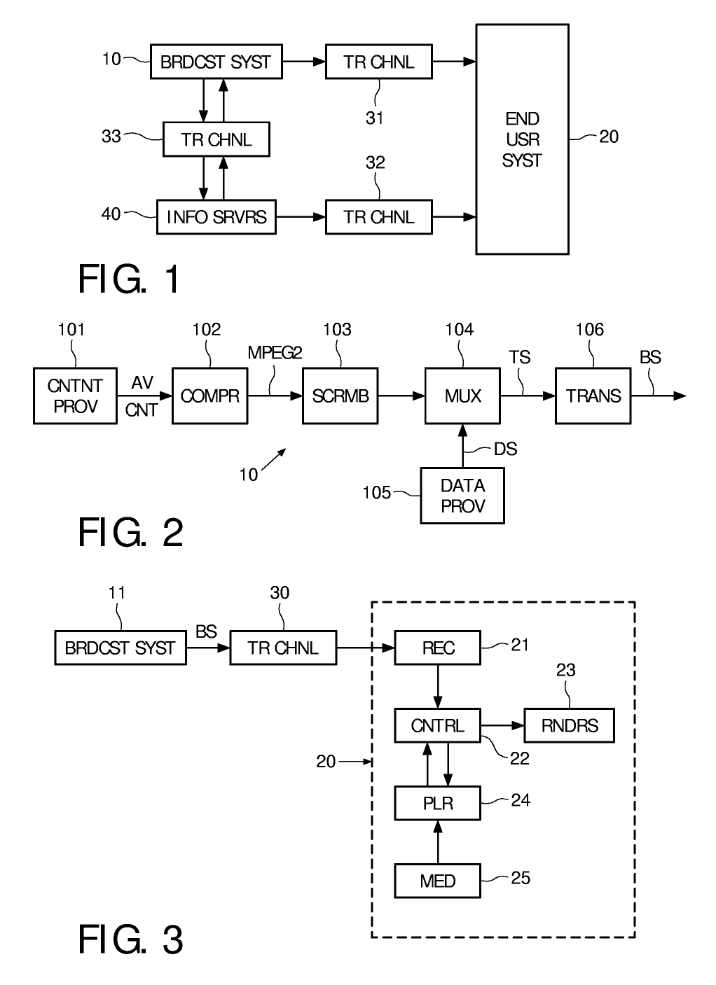

FIG. 1 shows schematically a block diagram of a typical transmission system;

FIG. 2 shows schematically a block diagram of a typical broadcast emission system to be used in the transmission system as illustrated in FIG. 1;

FIG. 3 shows schematically a block diagram of a transmission system according to an embodiment of the invention;

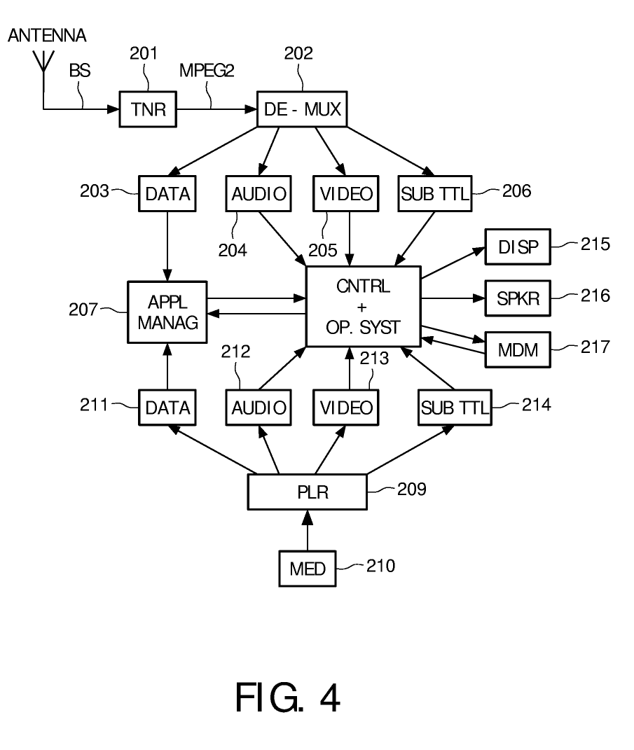

FIG. 4 shows schematically a block diagram of an end user system according to an embodiment of the invention;

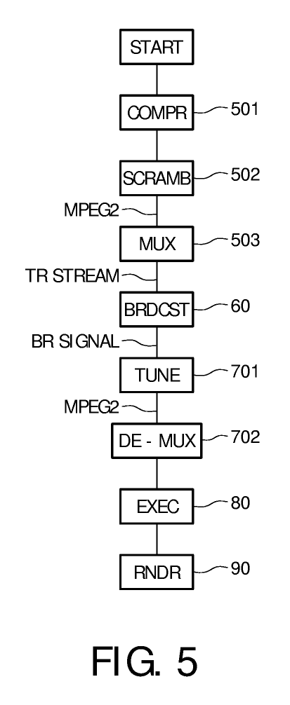

FIG. 5 illustrates by means of a flow diagram a method for combining information with broadcasted audio-video content according to an embodiment of the invention;

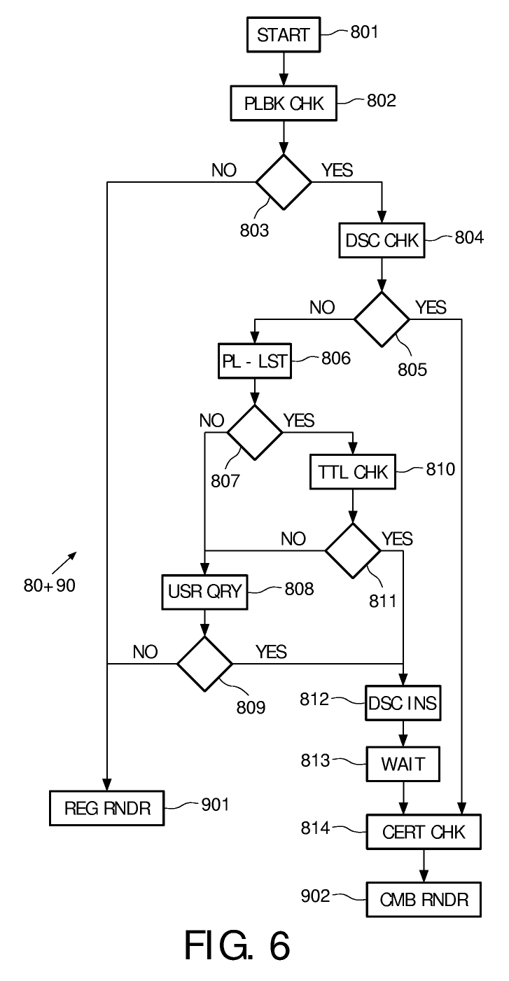

FIG. 6 illustrates by means of a flow diagram a detailed embodiment of the execution (80) and combined rendering steps (90) of the method as illustrated in FIG. 5.

FIG. 1 shows a typical digital transmission system as envisioned within the Digital Video Broadcast (DVB) platform. It may comprise a broadcast emission system (10), an end user system (20) and information servers (40), preferably the open Internet. These components may be connected to each other via several transmission channels (31,32,33). The details of the broadcast emission system and of the end user system will be discussed further with respect to FIGS. 2 and 4, respectively.

FIG. 2 shows a typical broadcast emission system (10). A content provider (101) supplies the audio-video content to be broadcasted. A compressor (102) compresses the audio-video content into an MPEG2 stream (MPEG2). Optionally, a scrambler (103) may scramble the MPEG2 stream by encrypting it under the control of a content key, then it delivers the MPEG2 stream to a multiplexer (104). In addition to the MPEG2 stream, the multiplexer (104) may also receive one or more scrambled or non-scrambled data streams (DS) and further digital signals from a data provider (105). The data provider (105) may be the same as the content provider (101). Returning to FIG. 1, part of the data streams (DS) may also be retrieved from information servers (40), for example Internet websites, by known transmission channels via known transmission protocols, for example TCP-IP. Returning to FIG. 2, a multiplexer (104) assembles the scrambled or unscrambled MPEG2 stream and the one or more data streams (DS) into a transport stream (TS) by time-multiplexing. The scrambling and multiplexing may be performed in separate units, and if desired, at different locations. The transport stream (TS) is supplied to a transmitter (106).

A typical broadcast emission system (10) operates as a multi-channel system, implying that the multiplexer (104) can handle information received from a number of (parallel) sources and interacts with the transmitter (106) to broadcast the information along a corresponding number of channels or multiplexed into separate transport streams. In addition to audio-video content, messages or applications or any other sort of digital data may be introduced in some or all of these services/channels interlaced with the audio-video content. As such a transport stream (TS) comprises one or more types of streams, also known to the person skilled in the art under the name services, each service comprising one or more service components. A service component is also known as a mono-media element. Examples of service components are a video elementary stream, an audio elementary stream, a subtitle component, a Java application (Xlet) or other data type. A transport stream (TS) is formed by time multiplexing one or more elementary streams and/or data.

The transmitter (106) broadcasts the transport stream in the form of a broadcasted signal (BS). Returning to transmission system as shown in FIG. 1, the broadcasted signal (BS) may be supplied to the to the end user system (20) in analog or digital form using well-known distribution channels as, for example, CATV cable or IEEE 1394. The distribution of the broadcasted signal (BS) may take place via several transmission channels (31), for example satellite, via terrestrial broadcast, cable transmission and/or combined satellite/cable. The party that distributes the broadcasted signal (BS) comprising the audio-video content via the delivery system is sometimes referred as the network provider.

Typical examples of end user systems (20), where the invention may be practiced, comprise set-top-boxes (STB), digital television units equipped with Digital versatile Disc (DVD) and/or Blu-ray Disc (BD) playback abilities, or computer based entertainment systems, also known under the name Home Media Servers. The end user system (20) preferably complies with a defined open platform like the European MHP (Multimedia Home Platform) or the US Dase Platform. These public platforms define several types of applications that may be recognized and executed by the end user system. For example, the European MHP platform specifies that applications may be included as Java TM applications, such applications known to the person skilled in the art under the name Xlets.

While not necessary for practicing our invention, a typical end user system (20) may use known communication protocols like TCP-IP to download information from information servers (40), preferably the Internet, the downloading taking place over known communication channels (32), for example cable or telephone/ADSL/ISDN lines.

FIG. 3 shows schematically a transmission system according to an embodiment of the invention. It comprises a broadcasting system (11), for generating a broadcast signal (BS) comprising an audio-video content and a data stream, a transmission channel (30), for example terrestrial broadcast, cable transmission and/or combined satellite/cable and an end user system (20). While possible, it is not required that the end user system (20) and the broadcasting system (11) to be connected to information servers (not shown in FIG. 3) via know transmission channels (not shown in FIG. 3). The end user system comprising a receiver (21), for retrieving from the broadcasted signal (BS) the audio-video content and the data stream, a controller (22) for executing the applications contained in the in data stream, a player (24) for retrieving information, for example audio-video content from a media (24) and rendering devices (23) (for example display and speakers).

Further details of an end user system (20) in which the present invention may be practiced will be discussed with reference to FIG. 4. A tuner (201) receives the broadcasted signal (BS) transmitted by the broadcasting system and extracts a separate tunable radio-frequency (RF) band, usually resulting in an MPEG2 transport stream. A demultiplexer (202) splices the MPEG2 stream into a data stream (203) and audio (204), video (205), and subtitle (206) streams. The audio, video and subtitle streams (204,205,206) are fed to a controller (208), which via a specific operating system controls all the software and hardware modules of the end user system. The audio/video content may also be passed through a conditional access sub-system (not shown in FIG. 4), which determines access grants and may decrypt data. The controller (208) converts the audio (204) and video (205) streams into signals appropriate for the video (215) and audio (216) rendering devices (for example display and speakers, respectively). The subtitle stream (206), usually a stream of image files with transparent backgrounds, may also be directly passed to a dedicated rendering engine with direct access to the video-rendering device (215).

The European Multimedia Home Platform (MHP) represents an open forum describing how applications may be executed on an end user system. The platform specifies that suitable applications are Java applications to be executed by a Java Virtual machine running on the end user system. This corresponds to an abstraction layer, known in the art under name the Application Manager, being present between any application to be executed by the end user system (20) and the specific system resources of the end user system (20). Consequently the Application manager allows applications to be carried over any Digital Video Broadcast (DVB) compliant network, independent of the specific end user system (20), for example on high or low end STBs, on integrated digital TVs or on home media servers.

Preferably the data stream (203) and the handling of the data stream (203) by the end user system both comply with the open European Multimedia Home Platform (MHP). Consequently, the applications comprised in the data stream are specifically Java applications known under the name Xlets. The data stream (203) outputted by the demultiplexer (202) is fed to the Application Manager (207). Any application comprised in the data stream (203) will be executed by the Application Manager (207).

The end user system may also comprise a media player/recorder (209). This may be for example a Blu-ray Disc (BD) or a Digital Versatile Disc (DVD) player and/or recorder, a hard disk or any other suitable device. The media player (209) extracts an encoded information stream, for example an MPEG2 stream, from a storage media (210), for example an optical disc or a hard disk, and splices it into separate audio (212), video (213), subtitle (214), and data (211) streams. The data stream (211) is fed to the Application Manager (207), while the audio (211), video (212) and subtitle (214) streams are fed to the controller (208).

An advantageous embodiment may be obtained when the information retrieving functions of the media player (209) can be accessed by the broadcasted application comprised in the data stream (203). For example it is expected that Blu-ray Disc (BD) players/recorders are able to execute Java Applications, at least several of those specified in the open software platform known under the name GEM (Globally Executable MHP)

A method for combining additional information with broadcasted audio-video content according to an embodiment of the invention is further explained with respect to FIG. 5 and may comprise the following steps. The audio-video content received from a content provider is compressed into an MPEG2 stream in the compression step (501). Optionally the MPEG2 stream may also be scrambled by encrypting it with an encryption key in step (502). In a multiplexing step (503), a multiplexer assembles a transport stream comprising the MPEG2 stream and one or more scrambled or non-scrambled data streams and further digital signals from a data provider. The application that is intended to enable the use of information stored locally is included in the multiplexing step into the transport stream. The transport stream is broadcasted by an emitter in the broadcast step (60). An end user system receives the broadcasted signal and extracts a tunable FF band in the tuning step (701). In a demultiplexing step (702), the application data and the audio-video content components are separated by a demultiplexer. For example, in the case of an MHP compliant system, the extracted application data is a Java Xlet that is executed by the Java Virtual Machine loaded into the Application Manager in the execution step (80). Consequently, the execution of the Java Xlet leads to the combined output step (90), comprising outputting of both the broadcasted audio-video content and of additional information that is extracted from a local media. For example, the combined outputting may take place as a picture-in-picture or as a text display of additional text information, extracted from the local media. Preferably, the rendering of the additional information takes place simultaneously with rendering the audio-video content.

The details of the execution (80) and combined rendering (90) method step according to an embodiment of the invention are further explained with reference to FIG. 6.

The execution of the broadcasted application is started by the Application Manager in step (801). In the checking step (802) the availability of suitable playback resources to the end user system is checked. Detailed embodiments of the checking step (802) will be discussed further on. The method proceeds to a decision step (803). If no suitable playback resources are found, the method proceeds to a standard rendering step (901). It should be noted that the standard rendering step (901) may contain interactive parts that make use of data content included with the broadcasted application or data content that is downloaded from the Internet, but the standard rendering step (901) does not make use of information stored locally. If suitable playback resources, for example a Blu-ray Disc (BD) player, have been identified, the method proceeds to identification of available media storing local information. If the available media contains the desired information, the method proceeds to a combined rendering step (902). It should be noted that, in view of the fact that certain media may require application authentication before the stored information is made available, the combined rendering step (902) may be preceded by a certificate check step (814). For example, in the case of Blu-ray Disc (BD) players, it is possible that only authenticated applications are allowed to run when a desired BD disc is played. Returning to the decision step (805), if the presently available media is not the desired one, the application proceeds to checking if a list of available media titles is present in the firmware memory of the end user system (806). For example, in the case of Blu-ray Disc (BD) players, such a list of available media titles may be maintained in the firmware memory. If such a list is available, in step 810, the presence of a desired title in the list is checked. The method proceeds to a decision step 811. If no title is found in decision step 811, or if in decision step 807 no title list was found, the method proceeds to a user query step 808, step in which the user is queried if the desired media title is available locally. If the user indicated that no desired media title is available, the decision step 809 is followed by the standard rendering step 901. If the user indicated a desired title is available, the decision step 809 is followed by a media insertion step 812, in which the user is asked to insert the corresponding media. Returning, if a desired title is found in the list in step 810 then the corresponding decision step 811 is followed by the media insertion step 812. In the waiting step (813) the application waits for the desired media to be inserted. After the media is inserted, optionally the authentication key is checked in step (814) and the combined rendering of locally stored information and of the broadcasted content is executed in the combined step (902).

With respect to a detailed embodiment of the checking step (802), the technical problem solved by the present invention relates to the fact that party that provides the broadcasted signal (the network provider) cannot know what specific playback resources are available to the end user system and no identification methods for playback resources have been disclosed. For example, the present implementation of the open Globally Executable MHP (GEM) standard does not specify any methods, functions and/or system properties that would allow a broadcasted application to determine what specific playback resources are available to the end user system.

In a first embodiment of the method, the checking step (802) of the method comprises interactively querying the user via a pop-up window over the specific playback resources available to the end user system. Based on the input from the user, in step 803 the method either proceeds to a standard rendering step (901), otherwise the method continues with the media checking step (804).

In a second, more advantageous embodiment of the method, the checking step (802) comprises directly attempting to playback a certain media type by directly executing the corresponding playback function. This embodiment alleviates the problem that an end-user might not be aware of the exact technical details of the end user system. For example, in case of an MHP compliant system this would correspond to attempting playing the desired type of media. If the playback function returns an error, it means that the desired type of playback resource is not available and the application may repeat the attempt to playback for another media type until all media types are checked or a suitable media playback resource is found. If no suitable media is found, in decision step 803 the method proceeds to the standard rendering step (901) otherwise it continues with the media checking step (804). In a more advantageous embodiment, the specific playback function is included in the broadcasted application stream comprised within the broadcasted data stream.

In a third embodiment of the method, the checking step (802) of the method comprises the broadcasted application using novel identification features of the end-user-system. For example, information with respect to available system resources is added in the firmware memory of the end user system. This may be implemented by software means known to the man skilled in the art as a system property. The information with respect to system resources may be included by the end-system's manufacturer before sale or can be provided later by means of a firmware update. Returning to the description of the method according to the invention, in one embodiment the firmware memory is inspected in the checking step (802) by the broadcasted application and the playback facilities are identified.

An alternative embodiment for the checking step (802) corresponds to adding to the end user system identification means, that allow the identification of available resources. This may be implemented by means of software known to the man skilled in the art as an identification function. When executed, the function outputs information with respect to available resources. Identification means may be included by the end-system manufacturer before sale or can be provided later by means of a firmware update. Returning to the description of the method according to the invention, in an alternative embodiment, the broadcasted application calls the identification function in the checking step (802) and available system resources are identified.

These embodiments for the checking step (802) obviates the problem that the method corresponding to the second embodiment fails in the case the application attempts to read information from certain type of removable media (for example BD-ROM disc) and no media of the corresponding type is inserted in the content player.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable programmed computer. A computer program may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measured cannot be used to advantage.

1. A method for combining a signal comprising additional information with a broadcasted signal representing audio-video content in order to enhance a user experience of the broadcasted content, comprising:
a signal generation step, comprising generating a broadcasted signal comprising the audio-video content and a control sequence;
an receiving step, comprising receiving the broadcasted signal by an end user system;
an extraction step, comprising extracting the audio-video content and the control sequence from the received broadcasted signal;
an execution step, comprising executing the control sequence by the end user system, the execution step resulting in;
a combined output step, comprising combined outputting of the broadcasted audio-video content and of the additional information;
the said method characterized by retrieving the additional information from information available locally to the end user system.

2. A method according to claim 1, characterized by further comprising:
a checking step for checking if a suitable player for reading the additional information stored locally is present in the end user system;
an identification step, comprising identifying if a desired media storing the additional information is available.

3. A method according to claim 2, characterized by using user feedback in the checking step.

4. A method according to claim 2, characterized by the checking step comprising executing a test control sequence for testing if the suitable player is present in the end user system in the checking step.

5. A method according to claims 4, characterized by the control sequence encoded into the broadcasted signal comprising the test control sequence.

6. A method according to claim 4, characterized by the test control sequence comprising a sequence operative to inducing the end-user-system to attempt reading information from the desired media.

7. A method according to claim 2, characterized by the checking step comprising checking information stored by the end user system, operative to determining whether a suitable player is present in the end user system.

8. A method according to claim 2, characterized by the checking step comprising executing a function available to the end user system, operative to determining whether a suitable player is present in the end user system.

9. A method according to claim 1, characterized by the control sequence further comprising information corresponding to an identification key allowing the playback of the desired media.

10. A method according to claim 1, characterized by using user feedback in selecting pieces of additional information to be used in the combined output step and in selecting a mode of usage for the pieces of additional information.

11. A method according to claim 2, characterized in that the desired media is an optical disc.

12. An end user system for rendering audio-video content, comprising:
means for receiving a broadcasted signal, comprising the audio-video content and a control sequence;
extraction means for extraction and separation of the audio-video content and of the control sequence from the broadcasted signal;
output means for outputting the audio-video content;
playback means for reading information from a desired media;
controller means for executing the control sequence and for controlling the playback means and the output means;
characterized in that the end user system further comprises identification means adapted to identify the presence of playback means.

13. An end user system as claimed in claim 12, characterized in that the identification means comprise means storing information locally whether a suitable player is available in the end user system.

14. An end user system as claimed in claim 12, characterized in that the identification means comprise function execution means, adapted to determining when executed whether a suitable content player is available in the end user system.

15. A transmission system comprising:
a broadcasting system for broadcasting audio-video content, comprising means for generating a broadcasted signal representing the audio-video content and additional data corresponding to a control sequence;
an end user system, comprising decoder means for decoding the broadcasted signal into an real-time audio-video stream, extraction means for extraction of the audio-video content and of the control sequence from the real time audio-video stream, output means for outputting the audio-video content, playback means for reading additional information from a desired media, controller means for executing the control sequences, for controlling the playback means and for controlling the rendering means;
the transmission system characterized in that the control sequence is operative to enable the end user system to generate a combined output of the broadcasted audio-video content with the additional information that is available locally.

16. A transmission system according to claim 15, characterized in that the control sequence is operative to enabling the controller means:
to determine if a suitable player for playing information stored locally is available;
to identify if a desired media is available.

17. A computer application product operative to implementing any of the control sequences used in implementing a method according to claim 1.

18. A computer application product operative to implementing any of the test control sequences used in implementing a method according to claim 4.

19. A computer application product operative to implementing the identification means of an end user system as claimed in claim 13.

20. A computer application product operative to implementing the execution means of an end user system as claimed in claim 14.

21. A broadcasted signal comprising:
information corresponding to an audio-video content;
information corresponding to a control sequence;
characterized in that the control sequence is arranged to enable an end user system to combine the audio-video content with additional information extracted from information stored locally at the end user system.

22. A signal according to claim 21, characterized in that the control sequence is arranged to enable checking whether a suitable player for reading the additional information stored locally is present in the end user system and identifying if a desired media storing the additional information is available.

23. A signal according to claim 21, characterized in that the control sequence further comprises a test control sequence arranged to allow the identification whether a suitable player is present in the end user system.
